(19) United States
(12) Patent Application Publication
(10) Pub. No.: US 2026/0298415 A1
(43) Pub. Date: Oct. 1, 2026

(54) HYDROGEN VENT NOZZLE

(71) Applicant: Airbus Operations Limited, Bristol (GB)

(72) Inventors: Nathan Alan ORMOND, Bristol (GB); Archie WEST, Bristol (GB); Mohammad ASLAM, Bristol (GB)

(21) Appl. No.: 19/573,789

(22) Filed: Mar. 20, 2026

(30) Foreign Application Priority Data
Mar. 28, 2025 (GB) 2504650.9

(51) Int. Cl. F17C 13/12

(52) U.S. Cl. CPC F17C 13/12; F17C 2205/0332; F17C 2221/012; F17C 2223/0161; F17C 2260/04; F17C 2270/0189

(57) ABSTRACT

A a hydrogen vent nozzle for hydrogen aircraft configured to reduce and mitigate the risk of icing. The vent nozzle has an outlet through which hydrogen exits, and a gap through which water exits, the water having entered the nozzle via the outlet. The gap is disposed in a location to which hydrogen will not flow due to the shape of the nozzle, and in a location to which water will flow under action of gravity. The outlet is disposed at the end of a second section of the vent nozzle, the second section being vertical. The vent nozzle is disposed on a vertical tailplane of the aircraft. Hydrogen is therefore vented upwardly and away from the aircraft, while water entering the vent nozzle drains out and does not accumulate, reducing the chance of icing.

### CROSS RELATED APPLICATION

This application claims priority to United Kingdom Patent Application GB 2504650.9, filed Mar. 28, 2025, the entire contents of which is hereby incorporated by reference.

### BACKGROUND OF THE INVENTION

The present disclosure relates to hydrogen venting. More particularly, but not exclusively, the present disclosure concerns an apparatus and method for venting of hydrogen from an aircraft.

Hydrogen has been identified as a potentially environmentally preferable alternative to traditional fossil fuels, such as kerosene, in use as a fuel source for aircraft. Some aviation technologies and operations may require relatively minor adjustments to utilise hydrogen, whereas some will require more significant alterations. The fuel storage system is one of the latter, due to the considerably different requirements and characteristics of hydrogen in comparison to traditional jet fuels.

Additionally, hydrogen is a highly flammable substance, with an ignition energy (that being the energy required to cause a substance to ignite) significantly lower than kerosene. Hydrogen has a large range of concentrations in atmospheric air for which ignition can occur.

Due to its very low boiling point, liquid hydrogen must be stored at very low temperatures and/or high pressures. It is well known in the art that hydrogen will occasionally need to be vented from hydrogen storage units, to prevent overpressure as hydrogen inside the storage unit evaporates. In the context of venting hydrogen from an aircraft, for example when stationary and on the ground, ground crew may be nearby and it is therefore important that such personnel are adequately protected from the risks associated with the nearby venting of hydrogen.

Hydrogen vents are used in land-based industrial facilities, the vented hydrogen typically being released through a tall metal vent stack with an exhaust that typically extends above the building and very far from the ground. Given the low density of gaseous hydrogen, the hydrogen exits the vent stack via the exhaust and safely dissipates in the atmosphere. This reduces any risk associated with the hydrogen igniting after it has been vented, as the vent stack channels the hydrogen far away from the facility / potential ignition sources, and also ensures that the exhaust is at a safe distance from personnel.

The present invention seeks to mitigate one or more of the above-mentioned problems. Alternatively or additionally, the present invention seeks to provide an improved hydrogen vent for aircraft.

### SUMMARY OF THE INVENTION

The present invention provides, according to a first aspect, a vent nozzle for venting a flow of cryogenic gaseous hydrogen from an aircraft. The nozzle may be in the form of a duct.

The vent nozzle comprises a first outlet disposed at an end of the nozzle, in a first region of the nozzle. The vent nozzle may terminate at the first outlet. The vent nozzle may be so shaped that, in use, substantially all, for example all, of the hydrogen exits the nozzle via the first outlet during a venting procedure (e.g. a procedure where hydrogen is vented from a source of hydrogen on the aircraft). During a venting procedure, hydrogen may be vented from the source of hydrogen on the aircraft via a vent terminating in the vent nozzle.

The vent nozzle further comprises a second outlet configured to drain water (for example water entering via the first outlet) from the nozzle under the action of gravity. The second outlet is disposed at a location along the nozzle, upstream of and at a lower position than the first outlet, in a second region of the nozzle. Upstream/downstream may be defined relative to the direction of flow of the hydrogen when venting (e.g. from the source of hydrogen to the first outlet). That is to say, upstream can be used to describe a position that encounters the flow of the hydrogen when venting before a downstream position. The second outlet may be defined by a hole in a wall of the vent nozzle. The second outlet may comprise a series of slats with a gap between each slat. The second outlet may therefore comprise several outlets each defined by a gap in-between the slats. The slats may be shaped, for example angled, to direct hydrogen away from exiting the nozzle via the second outlet. Additionally or alternatively, there may be a structure positioned upstream of the second outlet, within the vent nozzle that affects the direction of flow of hydrogen during venting. For example, the structure may be positioned and/or shaped so as to divert gaseous hydrogen away from the second outlet.

During use of an embodiment of the invention, water entering the first outlet (from water in the atmosphere for example from precipitation or humid air) exits the nozzle as liquid water through the second outlet under the action of gravity. The nozzle may comprise channels to direct the water towards the second outlet. The second outlet may be disposed on a bottom surface of the vent nozzle. The second outlet may be disposed at a local minimum point of the vent nozzle. The local minimum point may be the local minimum point immediately upstream of the first outlet. Additionally or alternatively, the second outlet may be positioned at a point on the nozzle at which the water will flow to under the influence of gravity.

Therefore, a vent nozzle may be provided which can effectively drain water, and thus prevent / reduce ice build-up in the nozzle, something that has been recognised as a particular risk on an aircraft. Providing an outlet (the second outlet) for draining water from the vent nozzle is, in accordance with embodiments of the present invention, done is such a way that the flow of hydrogen to and/or from the second outlet is restricted and preferably minimised. The vent nozzle may be so shaped that, in use, negligible amounts of hydrogen, if any, exit the nozzle via the second outlet during a venting procedure. Thus, when the vent nozzle vents hydrogen upwardly from an aircraft, the arrangement of the vent nozzle is such that there is a higher (preferably much higher) concentration of hydrogen at the first region (in which the first outlet exhausts hydrogen) than at the second region (at which the second outlet is provided for draining water). It may be that the vent nozzle is shaped such that, in use, at the first region the hydrogen concentration in the first region is double that of the hydrogen concentration in the second region, for example at least 10 times greater and optionally at least 100 times greater. The first region will in use typically be located above the second region.

The nozzle may be shaped with a feature which channels hydrogen in a direction towards the first outlet and/or away from the second outlet.

It is preferred that the second outlet of the vent nozzle has no moving parts, which might for example be prone to icing and affect the function of the vent nozzle. It is preferred that the first outlet of the vent nozzle has no moving parts (for example a cap or the like), which might for example be prone to icing and affect the function of the vent nozzle, or may introduce failure modes and reduced reliability. A cap that opens only during a venting procedure and is otherwise closed, could provide the benefit of protecting the vent nozzle from water ingress, but would carry the risk of icing potentially affecting the ability of the vent nozzle to vent hydrogen effectively.

The vent nozzle may further comprise a first section connectable at one end to a source of hydrogen. The first section may be connectable to the source of hydrogen via a series of intermediary valves/pipes, for example including or being part of the rest of the vent structure. The source of hydrogen may be an aircraft fuel tank. The source of hydrogen may be the fuel system of an aircraft engine. In use, one or more lengths of pipe may extend between the first outlet of the vent nozzle and the source of hydrogen, such that the separation in the horizontal direction of the first outlet and the source of hydrogen is several metres (e.g. more than 2 metres and optionally longer than 3 metres, and possibly more than 5 metres).

The first section may be immediately downstream of (and/or adjacent to) a check-valve, which permits fluid flow in the downstream direction through the check-valve and prohibits/restricts fluid flow upstream through the check-valve. The check-valve may thus prevent/mitigate air ingress into the series of intermediary valves/pipes between the first section and the fuel source. This may mitigate against mixing of air and hydrogen during a hydrogen venting procedure. The check-valve may be a sprung valve, whereby the sprung valve can be compressed by downstream fluid flow (and/or a pressure difference) to open a fluid pathway through the valve. In the absence of fluid flow downstream (or pressure difference), and/or with the presence of fluid flow upstream, the sprung valve may extend under the action of the sprung valve and/or upstream fluid flow to close the fluid pathway through the valve. The check valve may prevent/mitigate ingress of debris (for example insects, dirt, bird’s nests and the like) upstream of the check valve, where there may be a series of intermediary valves/pipes. The check valve may provide a backup defence against water ingress to such intermediary valves/pipes.

The first section may be substantially horizontal. Horizontal/vertical and intervening directions may be defined relative to the aircraft on which the vent nozzle is installed. The first section may extend in a straight line.

The vent nozzle may further comprise a second section. The second section may project upwardly relative to the first section. The second section may be substantially vertical. The second section may be downstream of the first section. The second section may extend in a straight line.

The vent nozzle may comprise a transitional section connecting the first and second sections. The relative shape of the first, second, and transitional sections, may create the regions of higher and lower hydrogen concentration (the first region and second region). In embodiments there may be a boundary, or interface, between each section – in other embodiments there may be no such discernible boundary or interface between the sections. The transitional section may comprise a bend. The boundary between the first section and the transitional section may be before (upstream of) a bend, or at a point along the bend. The boundary between the transitional section and the second section may be along the bend, or after the bend. The transitional section may comprise the entire bend, and optionally straight portions before and/or after, or may form a section only of a bend in the vent nozzle.

A longitudinal axis of the first section may, in use, be downwardly directed relative to the aircraft in the downstream direction. The angle between the longitudinal axes of the first and section sections may be between 90 and 30 degrees, for example between 90 and 60 degrees, for example between 90 and 80 degrees, for example 90 degrees. The transitional section may be a curved section, and/or a bended section. A vent nozzle may therefore be created with a local minimum point (at which the second outlet may be located) to which water will flow under the action of gravity.

Each section may be made from stainless steel. Each section may be at least 2mm thick in cross-section. This may ensure that the vent nozzle is structurally secure, and/or capable of withstanding lightning strikes. The vent nozzle may include a bonding strap for providing an electrically conductive path between the vent nozzle and a different part of the aircraft to which an end of the bonding strap may be connected. Such a bonding strap may, in use, thus provide lightning protection.

Each section may comprise insulation, for example a layer of insulation and/or vacuum-insulation. Vacuum insulation may be provided by way of double walls containing a vacuum.

The vent nozzle is preferably so configured (for example as a result of how it is installed on an aircraft, the material it is made from, its location on the aircraft, its shape and length during flight of the aircraft, and/or its structural strength) such that it can withstand the aerodynamic loads on it at cruise speed (for example, a speed of 800 km/h at 10,000m altitude).

The majority of the length (e.g. at least 75% of the length, optionally at least 90% of the length) of the vent nozzle may have a cross-sectional area that is at least 1,000mm². The cross-sectional area may be less than 25,000mm², and optionally less than 10,000mm². The cross-sectional area of at least one of the sections may be smaller than the cross-sectional area of the section immediately following it, for example the section immediately downstream of it. Therefore, the cross-sectional area of the first section may be smaller than the cross-sectional area of the transitional section, which may be smaller than the cross-sectional area of the second section. The relative size of the cross-sections may be defined in the region of the boundary between the sections (there may be a step-wise change in cross-sectional area at the boundary). The cross-section of each section may be concentric with the cross-section of the section immediately downstream, at the boundary between the sections. The footprint of the smaller cross-section may be entirely within the footprint of the larger cross-section at the boundary between sections. The section with the smaller cross-sectional area may start with a larger cross-sectional area and constrict to the smaller cross-sectional area. This may assist with channelling the gaseous hydrogen. There may be a bend between the first section and the second section.

An intermediate region may be defined between the inside surface of the section with the larger cross-sectional area, and the outside surface of the section with the smaller cross-sectional area. At least part of the intermediate region may be a gap defining the second outlet. The hydrogen may therefore exit the smaller cross-sectional area and enter the larger cross-sectional area, travelling away from the second outlet and towards the first outlet. This may reduce the chance of hydrogen exiting the vent nozzle via the second outlet.

There may be at least one structural support extending across the intermediate region. The at least one structural support may be a rib, or a mesh, or other suitable structure. The at least one structural support may be coated in a hydrophobic material. This may provide structural support to the vent. This may assist in preventing / reducing icing by preventing / reducing water buildup on the structural support. This may improve draining of water from the vent.

Substantially the entire area of the intermediate region may be in the form of the gap. Alternatively, only a portion of the intermediate region may define the gap. The rest of the region may provide a barrier to flow of fluid from the interior of the vent nozzle to the exterior of the vent nozzle. For example, the gap that would otherwise exist may be covered so that fluid cannot pass into it. For example, the gap which forms the water drain outlet (the second outlet) may be defined by a portion only of the intermediate region, for example at the bottom of the region.

There may be an overlap between sections in the longitudinal direction. The section with the smaller cross-sectional area may extend longitudinally into the section with the larger cross-sectional area. The section with the smaller cross-sectional area may thus comprise an extended section, extending into the following section. The hydrogen may therefore exit the smaller cross-sectional area at a point longitudinally along the following section, beyond the second outlet, and travelling away from the second outlet. This may reduce the chance of hydrogen exiting the vent nozzle via the second outlet.

Any one of the vent nozzle sections may have a circular cross section. The smallest cross-sectional area of any of the sections may be between 0.0005m² and 0.05m², possibly about 0.001m² or more and possibly less than 0.003m². The larger cross-sectional area may be at least one and a half times larger than the smaller cross-sectional area, for example at least double the size, for example at least triple the size. The length of the first section may be less than 10 times a diameter of the vent nozzle (the diameter for example being the median diameter of the vent nozzle, or optionally the diameter of the first outlet, or optionally the lowest diameter of the vent nozzle that extends for more than 5cm), for example less than 5 times the diameter, for example between 5 times and 2 times the diameter. This may reduce/minimise the mixing of hydrogen and air in the vent.

At least the second section and/or the transitional section of the vent nozzle may comprise a hydrophobic surface disposed on the inside surface of the section. Flow of water entering the vent nozzle may be assisted by the hydrophobic surface along the inside surface towards the second outlet. The water may be repelled from the hydrophobic material, which may further reduce accumulation of the water in the vent nozzle. The hydrophobic surface may be disposed at least partially on a lower surface of the nozzle, and therefore positioned in a location where water entering the nozzle via the first outlet is likely to be. The hydrophobic surface may extend at least partially between the first outlet and the second outlet, for example at least 50% of the distance between the first outlet and second outlet along an inside surface of the nozzle, for example at least 75% of the distance, for example at least 90% of the distance. This may be the distance in a longitudinal direction. At each longitudinal location where the hydrophobic surface is present, the hydrophobic surface may cover at least 30% of the internal cross section of the nozzle, for example at least 50%, for example at least 75%, for example at least 90% of the internal cross section of the nozzle.

Water on the hydrophobic material is therefore repelled from the hydrophobic material and towards the second outlet under the action of gravity and hydrophobic force. This may improve the draining of water from the vent nozzle.

The vent nozzle may be installed in the Vertical Tailplane (VTP) of the aircraft. This may be an advantageously remote position on the aircraft, and/or the highest point on the aircraft. The vent nozzle may be housed substantially entirely within the VTP of the aircraft. At least part of the first section of the vent nozzle (the section connectable to the source of hydrogen) may be housed within the VTP. The source of hydrogen to which the first section is connected may be separated from the VTP by a distance of at least 1 metre. The transitional section may be housed entirely within the VTP. The second section may protrude from the VTP when venting and optionally also during flight of the aircraft. The second section may protrude from the VTP when venting by at least 10cm. The second section may protrude from the VTP during flight of the aircraft by less than 1 metre, for example less than 50cm, preferably less than 20cm, and optionally less than 10cm. The second outlet may be disposed within the VTP. Water from the second outlet may be collected in a collection chamber. Alternatively or additionally, water from the second outlet may by cycled back out of the aircraft.

Optionally, the vent nozzle may be provided with a fairing to improve its aerodynamic performance during flight of the aircraft. It will be understood that any additional structure provided primarily as a result of the presence of the nozzle, such as for example the aforementioned optional fairing, should be discounted when determining the distance by which the vent nozzle protrudes from the aircraft.

The vent nozzle may be installed on an aircraft engine pylon. This may allow for rapid venting from the aircraft engines where necessary.

At least one section of the vent nozzle may be telescopic. The at least one section may therefore be configured to increase and decrease in length during use. This may allow for the second outlet to be moved further away from the aircraft. This may ensure access to the front and rear doors of the aircraft and improve turnaround time between flights. The change in length of the telescopic part of the vent nozzle between its fully extended configuration and its fully retracted configuration may be at least 10cm, optionally at least 25cm.

The at least one telescopic section of the vent nozzle may be the second section. Telescoping of the second section may extend the second outlet further above the ground and/or a door of the aircraft. The telescoping section may be driven by an actuator and/or motor. The telescoping section may be extended in a ground configuration. The telescoping section may be retracted in a flight configuration. The increase and decrease in length of the telescoping section may be controlled by a signal from a control unit. The control unit may provide a signal in dependence on whether the aircraft is on the ground. Additionally or alternatively, the control unit may provide a signal in dependence on whether the aircraft is below a threshold ground speed. The threshold speed may be a taxi speed of the aircraft, for example a speed below 30 knots (55.5 kph), for example a speed below 20 knots (37 kph), for example a speed below 10 knots (18.5 kph), for example when the aircraft is stationary. The control unit may receive signals from pre-existing aircraft sensors, for example a weight-on-wheels sensor, and/or a speed sensor. The telescopic vent nozzle may be manually actuatable. The control unit may provide a signal to extend if the aircraft is both on the ground and below the threshold speed. The control unit may provide a signal to retract if either the aircraft is not on the ground or is above the threshold speed.

The first section of the nozzle may also be telescopic. This may extend the outlet further from the aircraft in a horizontal and/or vertical direction, and/or a combination of the two.

The vent nozzle may be pivotable between the ground configuration and the flight configuration. Pivoting of the vent nozzle from the flight configuration may increase the height of the vent nozzle in the ground configuration. Pivoting of the vent nozzle from the ground configuration may retract the nozzle within the aircraft as described above. The second section may be vertical in the ground configuration. The second section may be angled to the vertical in the flight configuration by no more than 45 degrees, for example less than 30 degrees, for example less than 15 degrees. Pivoting of the vent nozzle may be controlled by the control unit. Pivoting of the vent nozzle may be driven by a rotary actuator. The vent nozzle may be manually pivotable.

According to a further aspect of the present invention, there may be provided a fuel system for an aircraft. The fuel system may comprise at least one fuel storage tank for storage of cryogenic hydrogen. The fuel storage tank may be housed in the fuselage and/or the wings of the aircraft. The fuel storage tank may be vacuum insulated. The fuel system may comprise an overpressure relief valve on said at least one storage tank. The overpressure relief valve may open when pressure in the storage tank due to evaporation of liquid hydrogen reaches a pre-defined limit. When open, the overpressure relief valve may permit gaseous hydrogen to exit the tank via the overpressure relief valve. The overpressure relief valve may close when the pressure in the storage tank has returned to a pre-defined value.

The fuel system may further comprise a vent system for venting gaseous hydrogen from the fuel storage tank via the overpressure relief valve. The vent system may be a series of pipes and/or valves. The vent system may terminate in a vent nozzle as described in the previous embodiment.

According to a further aspect of the present invention, there may be provided an aircraft comprising the fuel system of the previous aspect and/or a vent nozzle as described or claimed herein.

The aircraft (and/or the vent nozzle itself) may be configurable between a flight configuration and a further configuration, for example a ground configuration (during which the aircraft may be taxiing or stationary on the ground, for example). In the flight configuration, for when the aircraft is in flight, the first outlet may either protrude from the skin of the aircraft as mentioned above (preferably by less than 1m) or may not protrude at all. In the ground configuration, the vertical separation of the first outlet from the highest point of the highest passenger door may be at least 3m. It may be that the difference between (a) the vertical separation of the first outlet from a fixed point on the aircraft when in the flight configuration and (b) the vertical separation of the first outlet from the fixed point on the aircraft when in the ground configuration, is more than 5cm, for example more than 10cm.

In the flight configuration, the majority of the nozzle may be contained within the skin of the aircraft. The only part of the nozzle not contained within the skin of the aircraft may be the protruding first outlet. Therefore, the nozzle may be substantially protected from aerodynamic stresses during flight.

There may be a bonding strap providing an electrically conductive path between the vent nozzle and a different part of the aircraft, for example for the purpose of lightning protection.

According to a further aspect of the present invention, there is provided a vent nozzle for venting cryogenic hydrogen from an aircraft. The vent nozzle comprises a first section connected, via intermediary pipework, to a hydrogen tank. The vent nozzle comprises a second section, the second section projecting upwardly relative to the first section, and being downstream of the first section relative to the hydrogen tank. The vent nozzle comprises a transitional section between the first section and the second section. The vent nozzle terminates in a first outlet disposed on the second section. A second outlet is disposed at least partially on a bottom surface of the transitional section and/or in the first section. The vent nozzle comprises structure shaped to direct hydrogen towards the first outlet, and away from the second outlet. The structure may for example be a shielding structure disposed on one side of the outlet. This structure may prevent / reduce fluid flowing downstream through the vent nozzle from entering the second outlet, but permit fluid flowing upstream to enter the second outlet. The structure may channel the hydrogen in a particular direction, away from the second outlet. The structure may be the shape of the vent nozzle, such that the hydrogen is confined to a particular section of the nozzle.

According to a further aspect of the present invention, there is provided a method of venting gaseous hydrogen from an aircraft. The method comprises venting hydrogen through a first pipe, the first pipe directing the hydrogen along a first pathway. The method comprises directing the hydrogen from the first pipe directly into a second pipe. The second pipe has a larger cross-sectional area than the first pipe where the hydrogen passes from the first pipe into the second pipe. The longitudinal axis of the second pipe is angled to the longitudinal axis of the first pipe. For example, the angle may be between 30 and 95 degrees, for example between 45 and 95 degrees, for example between 60 and 90 degrees, and optionally between 75 and 90 degrees.

The second pipe extends in an upwards direction. An upwards direction may be a direction that is substantially vertical for example, within 45 degrees of vertical, for example within 30 degrees of vertical, for example within 10 degrees of vertical. The first and/or second pipes may each comprise transitional regions to transition between the longitudinal axis of the first pipe to the longitudinal axis of the second pipe.

The method further comprises releasing the hydrogen into the atmosphere via a hydrogen outlet. The hydrogen outlet is disposed on the second pipe, for example on an upwardly extending region of the second pipe.

Therefore, water which enters the second pipe through the hydrogen outlet passes out of the second pipe through a second outlet. The second outlet is a gap created between the first pipe and the second pipe at the interface. The gap may be created by virtue of the difference in cross sectional area between the first pipe and the second pipe where the hydrogen passes from the first pipe into the second pipe.

At least one of the pipes may be telescopic. The method may comprise the step of extending and retracting the at least one pipe between a flight configuration and a ground configuration. The extension and retraction may be effected in dependence on whether the aircraft is on the ground, and/or whether the aircraft is below a threshold speed, for example a speed below 30 knots (55.5 kph), for example below 20 knots (37 kph), for example below 10 knots (18.5 kph), for example when the aircraft is stationary.

When the venting occurs when the aircraft is on the ground, the second pipe may be in an extended configuration, and the method may include telescoping the second pipe into a retracted configuration during take-off, landing, and/or flight of the aircraft.

The method may comprise the step of collecting water passing through the second outlet in a storage chamber. The method may comprise releasing the water from the storage chamber to a location outside the aircraft when necessary.

The aircraft may be a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and optionally more than 75 passengers. The aircraft may be a commercial aircraft, for example a commercial passenger aircraft, for example a single aisle or twin aisle aircraft. The aircraft need not be configured for carrying passengers, but could for example be an aircraft of an equivalent size configured for cargo and/or used on a non-commercial basis. The aircraft may have a maximum take-off weight (MTOW) of at least 20 tonnes, optionally at least 40 tonnes, and possibly 50 tonnes or more. The aircraft may have an operating empty weight of at least 20 tonnes, optionally at least 30 tonnes, and possibly about 40 tonnes or more.

The present disclosure also provides for a telescoping vent nozzle, which may have an arrangement of one or more outlets for liquid / gas different from that described above. For example, there may be provided a vent nozzle for venting a flow of cryogenic gaseous hydrogen upwardly from an aircraft, wherein at least one section of the vent nozzle is telescopic so that it is configured to increase and decrease in length during use. For example, the vent nozzle may be configured to telescope between a flight configuration and a ground configuration, preferably such that in the flight configuration (e.g. for when the aircraft is in flight) any part of the nozzle which protrudes from the skin of the aircraft protrudes by less than 1m or the nozzle does not protrude at all, and such that in the ground configuration (e.g. for when the aircraft is taxiing or is stationary on the ground), the length of the nozzle is greater by a distance of at least 5cm (optionally more than 10cm longer, and possibly more than 20cm longer) so that a part of the nozzle protrudes further from the skin of the aircraft than in the flight configuration.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a view of an aircraft incorporating a hydrogen vent nozzle according to a first embodiment of the invention;

FIG. 2 shows a hydrogen vent nozzle according to a first embodiment of the invention;

FIG. 3 shows a cross-sectional view of the hydrogen vent nozzle along line A:A according to a first embodiment of the invention;

FIG. 4 shows an alternative cross-sectional view of the hydrogen vent nozzle along line A:A according to a first embodiment of the invention;

FIG. 5 shows a hydrogen vent nozzle according to a first embodiment of the invention during hydrogen venting;

FIG. 6 shows a hydrogen vent nozzle according to a first embodiment of the invention during water draining;

FIG. 7 shows a hydrogen vent nozzle according to a first variation of the first embodiment of the invention;

FIG. 8 shows a hydrogen vent nozzle according to a second variation of the first embodiment of the invention;

FIG. 9 shows a hydrogen vent nozzle according to a second embodiment of the invention;

FIG. 10 shows a hydrogen vent nozzle incorporating a telescopic section according to a further embodiment of the invention; and

FIG. 11 is a flow diagram illustrating a method performed in respect of venting hydrogen from an aircraft according to a further embodiment of the invention.

### DETAILED DESCRIPTION

Embodiments of the present invention relate to a vent for the venting of cryogenic gaseous hydrogen from an aircraft powered at least partially by liquid hydrogen (“LH2”). Due to the low boiling point of hydrogen at atmospheric pressure (~20K), gaseous hydrogen will typically need to be vented from a store of LH2. Venting may be effected whilst the aircraft is on the ground, and may be a planned operation during fuelling / defuelling operations. Venting may also be required from time to time in view of gas pressures within storage tanks or pipework exceeding threshold levels. Venting may be required during flight also. The design and implementation of a vent for an aircraft may involve consideration of factors that are in addition to and/or different from those considered in relation to non-aircraft applications.

Aircraft regularly operate at altitudes above 30,000 feet (9.1km) and at temperatures below -30° C. (243.15 K) and regularly travel at speeds in the region of 300 and 1,000 km/hour.

Due to the temperatures involved with LH2 generally, and the lower temperature of air at altitude, management of water in the atmosphere which may enter the vent is a key consideration of the vent design for an aircraft, to prevent / reduce icing.

When an aircraft is on the ground, for example at an airport, personnel are regularly required to be in the aircraft’s vicinity, for example for fuelling, maintenance, or cargo loading. Passengers may also be present in or near the aircraft. Therefore, it is important that any hydrogen exiting a vent into the atmosphere be a safe distance from such personnel / potential ignition source. Thus, if hydrogen is to be vented whilst the aircraft is on the ground it may be more practical to vent from a high location on the aircraft, in an upwardly direction, as the hydrogen can then rise away from the aircraft once vented. In relation to an aircraft, the use of a very tall exhaust vent stack with an outlet at a very a high location relative to the ground, and significantly higher than the highest part of the aircraft, would not be practical in view of the conditions during flight of the aircraft, particularly the likely aerodynamic performance during flight.

Having an upwardly extending vent stack, exposed to the external atmosphere, also increases the potential for water to enter the vent, increasing the risk of icing at high altitude. Preventing / reducing water accumulation in a hydrogen vent on an aircraft with the use of, for example, a hinged cap over the vent outlet (which can be pushed open by venting hydrogen) might be undesirable on an aircraft, as the cap itself may also be more susceptible to icing, and therefore blocking the vent. Such a cap might also be subject to mechanical failure, such as becoming jammed.

Adding drain holes in a hydrogen vent for water to escape from is not a practical solution to employ on an aircraft, if by so doing hydrogen is able to escape from the vent via the drain holes to any significant extent, particularly if for other reasons such drain holes need to be relatively low down when the aircraft is on the ground. Further, small drain holes may be prone to icing.

The present embodiments seek to provide a system which can cope with these competing considerations.

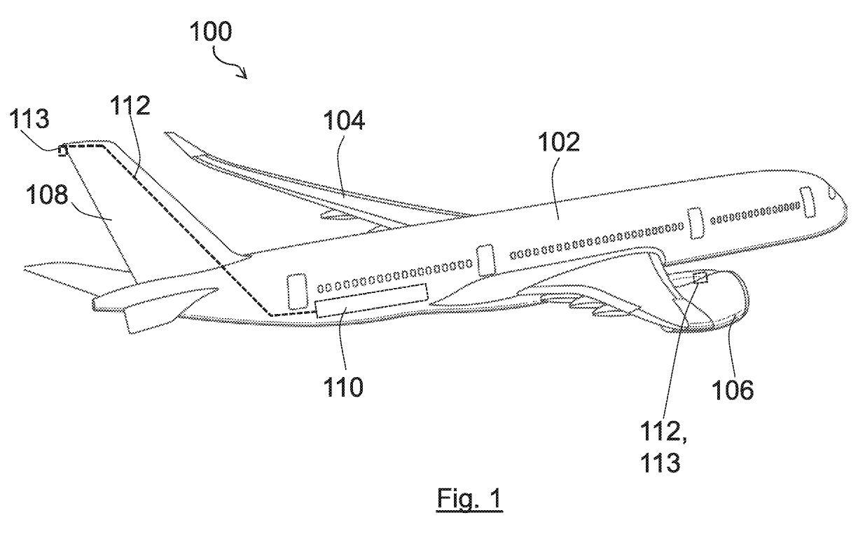

FIG. 1 shows an aircraft 100 with fuselage 102, wings 104, and engines 106. The aircraft 100 also has a vertical tailplane (“VTP”) 108. The aircraft is fuelled by LH2. The LH2 is stored in one or more tanks in the fuselage, indicated highly schematically by dashed box 110. The tanks will be suitable for the storage of LH2, and will therefore comprise elements such as vacuum insulation and an overpressure relief valve. It may also be that some LH2 is stored in one or more tanks in the wings 104. In use, LH2 is transferred from the one or more tanks 110 to the engines 106 to be used as fuel.

During storage, quantities of the LH2 will evaporate. This hydrogen is vented from the aircraft at the VTP 108, via a vent, illustrated schematically by dashed line 112. It will be appreciated that the shape of dashed line 112 is not necessarily an accurate depiction of the path of the vent, it is merely intended to be illustrative of the conveyance of hydrogen from the one or more tanks 110 to the VTP 108. The vent 112 terminates in a vent nozzle, schematically illustrated by dashed box 113, through which the hydrogen exits to the atmosphere. The vent nozzle 113 here is illustrated as being at the rear end of the VTP, towards the top. The vent nozzle 113 may also be on the top surface, towards the rear of the VTP. There may also be vents 112 (terminating in vent nozzles 113) on the engines 106. For clarity, the system of the vent 112 on the engine and its associated vent nozzle 113 (on the corresponding engine pylon) is illustrated in FIG. 1 as a single schematic box. The vent nozzle may be integrally formed with the vent, or section of vent, with which it is associated or may be connected thereto via one or more joints.

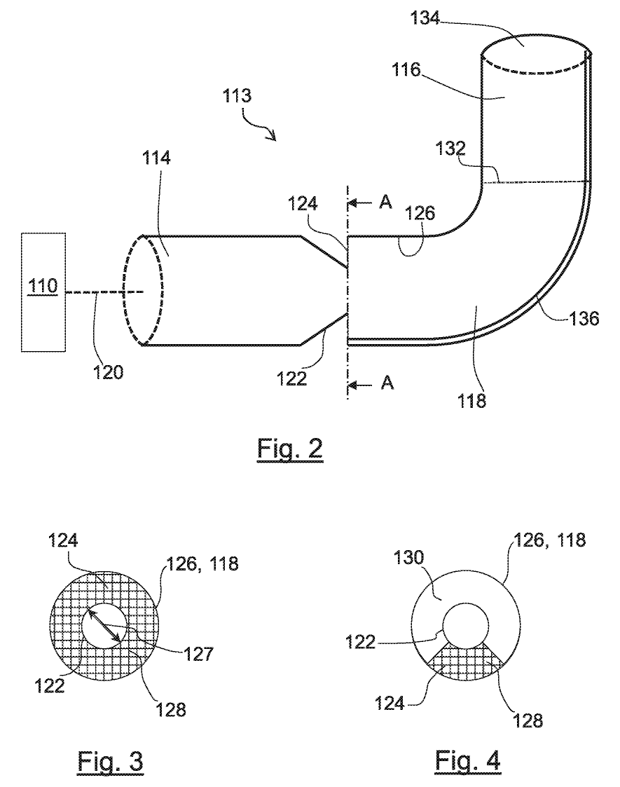

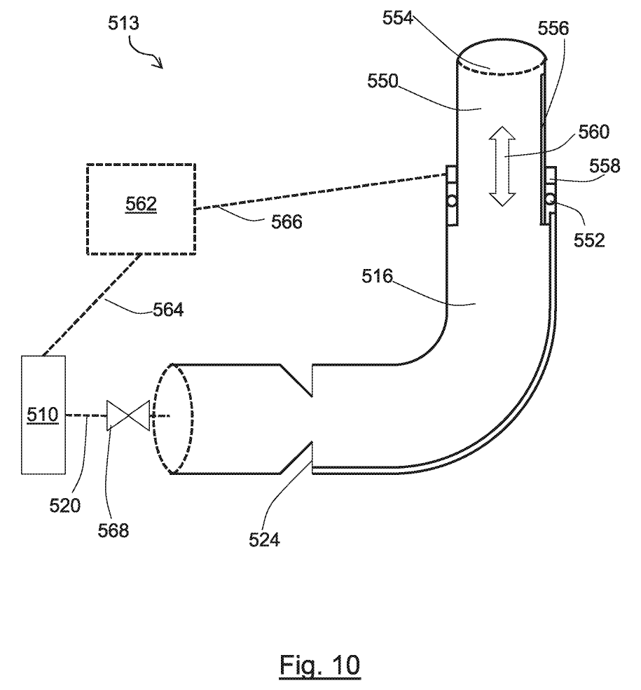

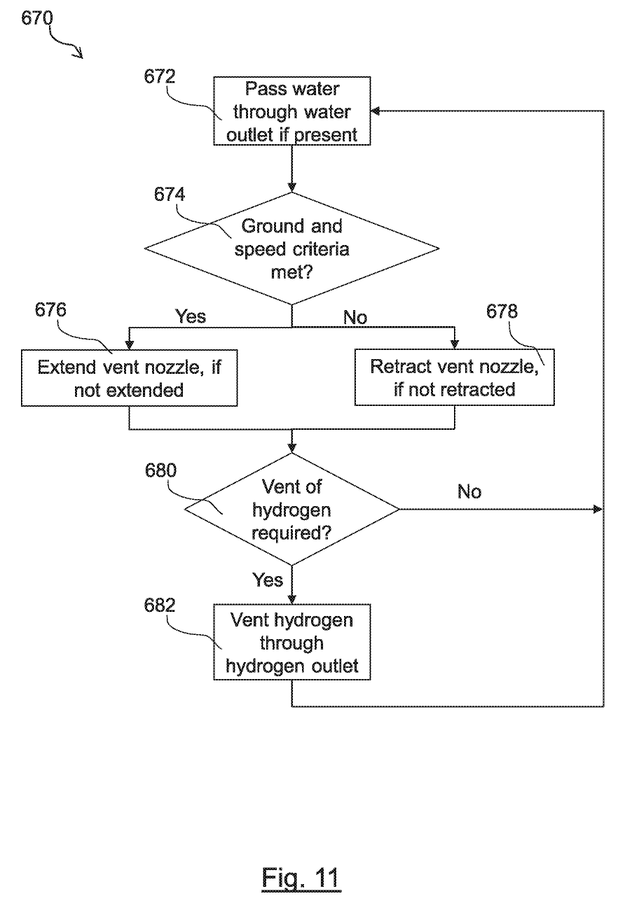

FIG. 2 shows a vent nozzle 113 in accordance with an embodiment of the present invention. The vent nozzle 113 is in the form of a pipe comprising a first section 114, a second section 116, and a transitional section 118 connecting the first 114 and second 116 section. The longitudinal axis of the first section 114 is horizontal, the longitudinal axis of the second section 116 is vertical, and the transition section 118 comprises a bend between the two. In this embodiment, all three sections have circular cross-sections, and are made from stainless steel. The stainless steel is at least 2mm thick in cross-section. Further, all three sections are vacuum-insulated. The first section 114 of the vent nozzle 113 connects at one end to the LH2 storage tank(s) 110, in this case in the fuselage (not shown in FIG. 2). It will be appreciated that there may be various interim elements such as valves/other pipework/the rest of the vent 112 (not depicted in FIG. 2) in varying directions etc. between the storage tank(s) 110 and the part of the first section 114 depicted in FIG. 2. These interim elements are depicted by dashed line 120, but it will be appreciated that they are not relevant to the description of this embodiment. A statement that the first section 114 is ‘connected’ to the LH2 store should be understood to encompass these interim components. The first section 114 is immediately downstream of a check valve (shown in FIG. 10), which prevents/reduces upstream flow of fluids through the valve (i.e. from the first section 114 into the interim elements 120) and permits downstream flow of fluids through the valve (i.e. from the interim elements 120 to the first section 114).

The cross section of the first section 114 constricts where the first section 114 and the transition section 118 meet (along plane indicated by dotted line A-A). This is the constricted end 122 of the first section 114, downstream from the interim elements 120. The two sections are in fluid communication with each other so that gas can pass from the first section 114 entirely to the transition section 118, via the constricted end 122. The cross-sectional area of the transitional section 118 is larger than the constricted end 122 so that a gap 124 (shown more clearly in FIGS. 3 and 4) is formed between the wall 126 of the transition section 118 and the wall of the constricted end 122.

FIG. 3 shows a section view along line A:A in FIG. 2 according to an embodiment of the present invention. The diameter of the constricted end 122, represented by arrow 127, is 2 inches (~5cm). This ensures that in the event of abnormal heat ingress (where more hydrogen will need to be vented than in normal operation), the vent system can still reliably vent the required quantity and flow-rates of hydrogen. There is a mesh 128 between the two walls, to provide structural support between the two items. The mesh is coated in a hydrophobic material. It will be appreciated that provision of a structural support can be achieved in a variety of ways, different from the mesh, without detracting from the function of the present embodiment.

FIG. 4 shows a section view along line A:A in FIG. 2 according to a variation of the previous embodiment. Here, a portion of the space between the wall 126 of the transition section 118 and the wall of the constricted end 122 is covered by a panel 130. Only a portion at the bottom of the transition section 118 is not covered by the panel 130, creating a smaller gap 124. Again, a mesh 128 is present for structural support. The mesh is unchanged from FIG. 3, but is simply not visible due to the presence of the panel 130. The panel 130 may be a part of the structure of the constricted end 122, or a part of the structure of the transition section 118, or may be a separate item entirely.

Referring now back to FIG. 2, after the interface between the first section 114 and the transition section 118, the transition section 118 bends in an upward direction. The interface between the second section 116 and the transition section 118 is represented by dotted line 132. The second section 116 terminates in an outlet 134. With the length of the first section 114 being about 100mm, its length is about double the diameter (about 50mm) of the outlet 134 and of the diameter (also about 50mm) of the nozzle generally.

A hydrophobic material 136 is applied to a portion of the inside surface of the second section 116 and transition section 118.

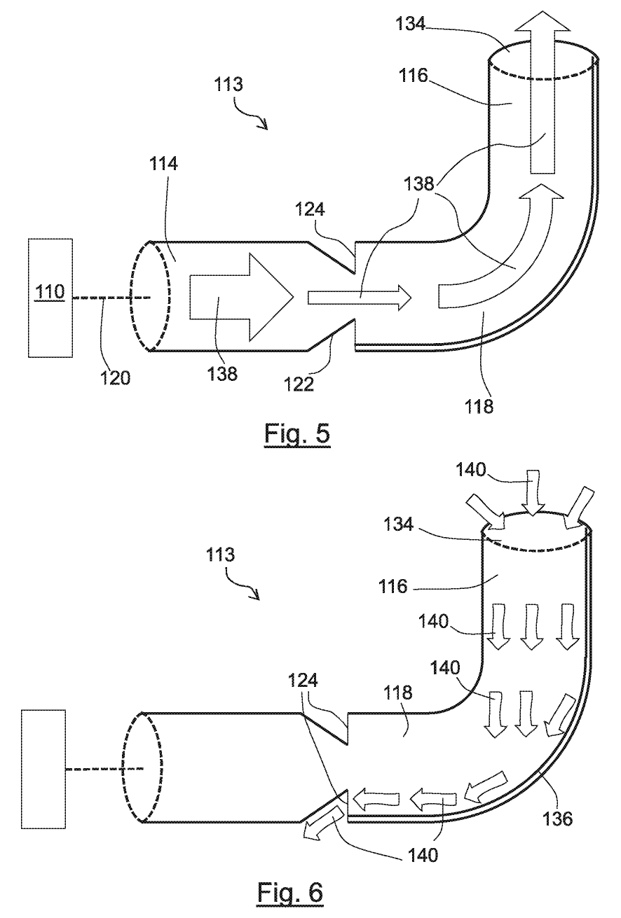

Use of the vent nozzle 113 will now be described in reference to FIGS. 5 and 6. The apparatus is identical to that of FIG. 2 (for clarity, only relevant elements have been relabelled). During a venting operation, gaseous hydrogen travels from the hydrogen store 110, along the vent and other interim elements 120 which make up the vent apparatus, into the first section 114 of the vent nozzle 113. Gaseous hydrogen, represented by arrows 138 on FIG. 5, is channelled through the constricted end 122 and enters the transition section 118. It will be readily apparent that such channelling ensures that the hydrogen travels away from the gap 124, so does not pass through the gap 124. The hydrogen then follows the shape of the transition section 118 and second section 116, thus exiting in an upward direction through outlet 134. The hydrogen will of course fan out after passing through the constricted section, but the direction of flow will be away from the gap 124. This means that gaseous hydrogen primarily exits through the outlet 134, with little or negligible hydrogen exiting via the gap 124. Thus, the concentration of hydrogen in the region of the gap 124 is significantly lower than in the region of the outlet 134.

FIG. 6 shows the case where water, represented by wavy arrows 140 (not every arrow has been labelled, for clarity purposes), enters the second section 116 of the vent nozzle 113 via the outlet 134. Under the action of gravity, the water falls onto the lower surface of the transition section 118 which, in this embodiment, comprises a hydrophobic surface 136. Water is guided, by the action of gravity and momentum, along the hydrophobic surface towards the gap 124. The presence of the hydrophobic surface further prevents/reduces water accumulation, propelling the water towards the gap 124 with hydrophobic force. The water drains out the vent nozzle 113 through the gap 124 to a dedicated collection area (not shown) where it can be disposed of in due course. Thus, the water is not able to accumulate in the vent nozzle 113 and cause icing.

The above described embodiments thus provide a simple and effective system for the venting of hydrogen from an aircraft. The hydrogen is vented in an upwardly direction, ensuring that the hydrogen is vented away from people/infrastructure/the aircraft, especially when on the ground. The lack of moving parts in the design reduces both potential points of failure and maintenance requirements. Icing is prevented / reduced in the design without use of a physical barrier (e.g. a cap over the outlet), thereby reducing the risk of the vent nozzle being blocked and/or locked closed. The positioning of the gap through which water flows is such that the amount of hydrogen passing through said gap, if any, is sufficiently low to be deemed acceptable. Further, the system is passive, such that there is a minimal requirement of computers/electronics and therefore points of failure.

Variations on the above embodiment will now be described. Like elements are indicated by reference numerals incremented by 100.

FIG. 7 displays a vent nozzle 213 which is the same as that of FIG. 2 (for clarity, only relevant elements are relabelled), except that the constricted end 222 is positioned further along the vent nozzle 213. More specifically, the constricted end is positioned on the bend between the horizontal and vertical orientation. This ensures that hydrogen passing from the first section 214 into the transitional section 218 is directed in at least a partially upwards direction by the action of the constricted end 222. A vertical dotted line 242 represents a threshold defined by the outlet 234, which the gap 224 should be behind. This ensures that if water enters the outlet 234 and travels vertically down along the line 242, which is a limiting case, it will still exit through the gap 234 rather than entering the first section 214.

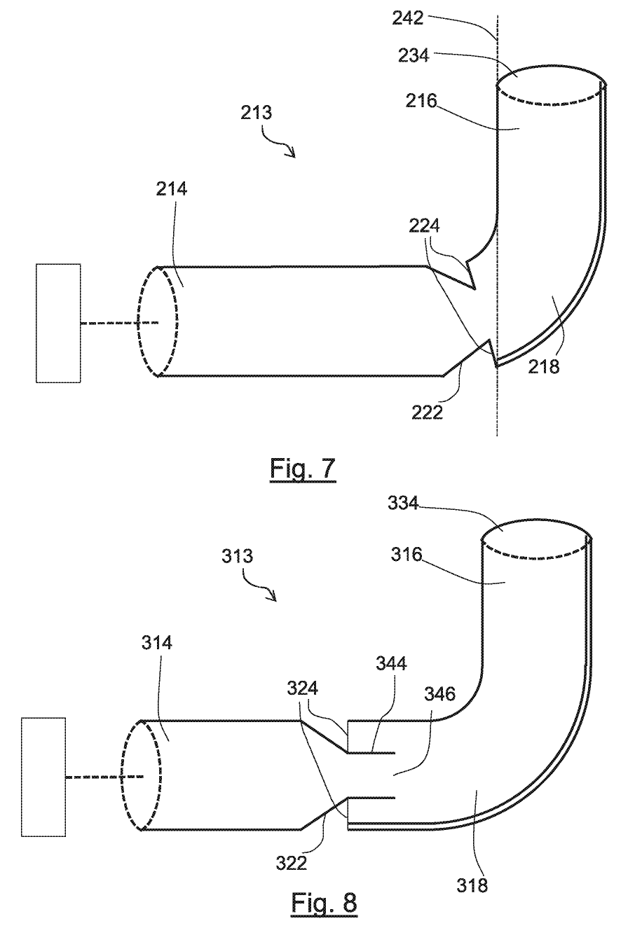

FIG. 8 displays a vent nozzle 313 which is the same as that of FIG. 2 (for clarity, only relevant elements are relabelled), except that the constricted end 332 has an extended section 344 of constant cross-section, which terminates in an outlet 346 partway along the transition section 318. Hydrogen passing into the transition section 318 from the first section 314 via the constricted end 322 and extended section 344 will therefore exit the outlet 346 downstream of the gap 324, travelling away from it.

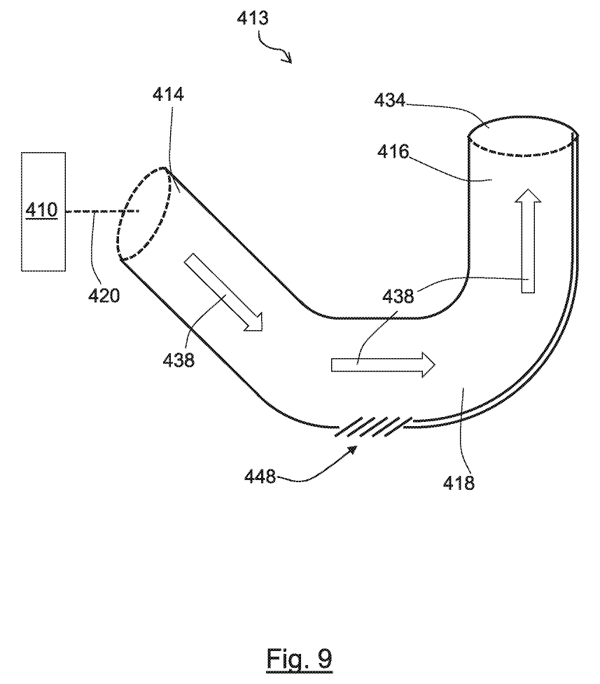

FIG. 9 displays a vent nozzle 413 according to a further embodiment of the present invention. This embodiment also comprises a first section 414 connected, possibly via further sections of vent and other interim elements 420, to one or more storage tanks 410. The transition section 418 comprises several sequential slats 448 defining gaps through which water can drain. These slats are positioned at a local minimum point of the vent nozzle 413 immediately preceding the second section 416, such that water which enters the outlet 434 is encouraged towards the slats 448 by gravity. Gaseous hydrogen flowing from the storage tank(s) 410 flows through the interim elements 420 and out the outlet 434, as indicated by arrows 438. The slats 448 are angled to direct hydrogen flowing downstream in a generally upwards direction, away from the gaps between the slats 448. Due to the lower density of gaseous hydrogen compared to air, the direction of flow, and the shape, direction, and configuration of the slats 448, little or negligible gaseous hydrogen flows out of the vent nozzle 413 via the gaps between the slats 448. This means that gaseous hydrogen primarily exits through the outlet 434.

FIG. 10 displays a vent nozzle 513 according to a further embodiment of the present invention. In this example, all elements of the vent nozzle 513 are identical to vent nozzle 113 of FIG. 2, except where discussed below. The second section 516 of vent nozzle 513 comprises a telescoping section 550. The telescoping section 550 sits within the second section 516, and comprises a seal 552 between the telescoping section 550 and the second section 516, to prevent/reduce hydrogen leaking. The telescoping section 550 terminates in an outlet 554, and may further comprise a hydrophobic layer 556 on an inside surface of the telescoping section 550. The vent nozzle 513 also comprises a motor 558 to drive the telescoping section in vertical motion in either direction, as indicated by arrow 560. Use of the telescoping section 550 allows the outlet 554 to be moved to a higher position above the ground when necessary and suitable (for example when the aircraft is on the ground and below a threshold taxi speed of 50kph), and retracted back to a position entirely within the second section 516 when not necessary and suitable (for example when the aircraft is in flight and/or above a threshold speed of 50kph). A system, indicated by dashed box 562, comprises sensors, and a CPU. Said system is arranged to detect (indicated by line 564) when the aircraft is on the ground, and the speed of the aircraft, and communicate (indicated by line 566) with the motor 558 to extend/retract the telescoping section 550 as necessary. Alternatively, the system 562 could communicate with the motor 558 to extend the telescoping section 550 only when both the aircraft is on the ground and a hydrogen vent is anticipated, e.g. by a measure of the pressure in the hydrogen storage tank(s) 510.

FIG. 10 also illustrates a check valve 568, disposed upstream of the gap 524. The check valve prevents/reduces ingress of debris such as insects, dirt, birds’ nests and the like, into the system. It is disposed upstream of the gap 524 to reduce the risk of icing. Such a check valve can be applied to the previous embodiments. The first section 524 is disposed immediately downstream of, and adjacent to, the check valve 568. The intermediary elements 520 are located immediately upstream of the check valve 568. The check valve 568 is a sprung one-way valve that allows flow in one direction (i.e. downstream), but in the absence of a pressure differential to cause flow in that direction will close, thus substantially preventing flow in the opposite direction (i.e. stopping flow upstream) and only permitting flow when the pressure differential overcomes the spring force. Thus, the sprung valve can be compressed by fluid flow in the downstream direction to create a fluid pathway through the valve. In the absence of fluid flow in the downstream direction, and/or with the presence of fluid flow in the upstream direction, the sprung valve extends under the action of the spring and/or upstream fluid flow to close the fluid pathway.

FIG. 11 shows a flow diagram illustrating a method 670 according to a further embodiment of the present invention, which could utilise the apparatus of any previous embodiment. The method is performed in respect of venting hydrogen from an aircraft through a vent, said vent terminating in a vent nozzle.

The method 670 includes a step of passing 672 water through a water outlet on the vent nozzle, if water is present. Any water entering the vent nozzle may pose an icing risk. The water outlet is at a point on the nozzle to which water will be guided under action of gravity.

The next step comprises determining 674 if the aircraft is on the ground and below the threshold speed. This may utilise systems already present on the aircraft, such as a Weight on Wheels system and speed sensing system. If the aircraft is on the ground and below the threshold speed, the method comprises a step of extending 676 the vent nozzle. Extension of the vent nozzle is performed by a motor. The vent nozzle is extended such that its outlet is further away from the ground. If the nozzle is already extended, then the motor takes no action.

If the aircraft is not on the ground, and/or above the threshold speed, the method comprises a step of retracting 678 the vent nozzle. This action is also performed by the motor, and returns the vent nozzle to an in-flight position. If the vent nozzle is already retracted, then the motor takes no action.

After extension 676 or retraction 678 of the vent, or determination that no action needs to be taken, there is a step of determining 680 whether a vent of hydrogen is required. This may be passively done, e.g. by an overpressure relief valve on a hydrogen storage tank which opens automatically in dependence on the pressure in the tank. In the case where hydrogen does not need to be vented, the system continues on as before, i.e. passing water through the water outlet 672 and extending 676/retracting 678 the vent nozzle if required. If venting is required, the hydrogen is vented through the vent system and out an outlet. The system then continues on as before i.e. passing water through the water outlet 672 and extending 676/retracting 678 the vent nozzle if required.

Embodiments of the invention therefore provides for an apparatus and method suitable for venting of hydrogen from an aircraft. Icing is mitigated through a water drainage system, with a passive system to prevent/reduce hydrogen entering the water drain. The system is transportable, and not cumbersome and prone to icing as with prior art versions. There are few moving parts, if any, and therefore reduced points of failure.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The vent nozzle may be located elsewhere on the aircraft, for example any suitable location where hydrogen venting may be necessary.

The vent nozzle may be applicable to other vehicles. For example, Ground Support Equipment transporting quantities of liquid hydrogen, for example for refuel operations, may also need to vent hydrogen.

The aircraft may be powered by hydrogen fully or in part. The engines may be powered by combustion of hydrogen or the engines may be electrically powered engines using electricity from hydrogen fuel cells.

In the case of the telescoping vent, other mechanisms - for example, passive systems – could be employed in addition to or instead of a motor-driven mechanism.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

The term ‘or’ shall be interpreted as ‘and/or’ unless the context requires otherwise.

1. A vent nozzle for venting a flow of cryogenic gaseous hydrogen upwardly from an aircraft, the vent nozzle being shaped to direct the flow so that at a first region there is a higher hydrogen concentration in the nozzle and at a second region there is a lower hydrogen concentration in the nozzle, the nozzle further comprising:
a first outlet disposed at an end of the nozzle, in the first region, and
a second outlet disposed at a location along the nozzle, upstream of and at a lower position than the first outlet, in the second region, the second outlet being configured to drain water entering the first outlet from the nozzle under the action of gravity.

2. The vent nozzle according to claim 1, wherein the nozzle further comprises:
a first section connectable at one end to a source of hydrogen,
a second section projecting upwardly relative to the first section, downstream of the first section, and
a transitional section connecting the first and second section.

3. The vent nozzle according to claim 2, wherein an internal cross-sectional area of the vent nozzle at either of the first section and the transitional section is smaller than a cross-sectional area of the vent nozzle downstream.

4. The vent nozzle according to claim 3, wherein an intermediate region is defined between the inside surface of the vent nozzle with the larger cross-sectional area, and the outside surface of the vent nozzle with the smaller cross-sectional area, at least part of this intermediate region being a gap which defines the second outlet.

5. The vent nozzle according to claim 4, wherein there is at least one structural support extending across the intermediate region, and wherein said at least one structural support is coated in a hydrophobic material.

6. The vent nozzle according to claim 4, wherein a portion only of the intermediate region forms the gap defining the second outlet, whereas the rest of the intermediate region provides a barrier to flow of fluid from the interior of the vent nozzle to the exterior of the vent nozzle.

7. The vent nozzle according to claim 4, wherein the smallest cross-sectional area of any of the sections is between 0.001m² and 0.003m².

8. The vent nozzle according to claim 2, wherein at least the second section of the vent nozzle comprises a hydrophobic surface disposed on the inside surface of the at least second section so as to assist the flow of water along the inside surface towards the second outlet.

9. The vent nozzle according to claim 8, wherein the hydrophobic surface extends at least partially between the second outlet and the first outlet.

10. The vent nozzle according to claim 1, wherein the vent nozzle is installed in the vertical tailplane of the aircraft.

11. The vent nozzle according to claim 1, wherein the vent nozzle is installed on an aircraft engine pylon.

12. The vent nozzle according to claim 10, wherein the vent nozzle is installed such that there is a structural connection of the vent nozzle to the aircraft and such that there is a bonding strap providing a separate connection between the vent nozzle and the aircraft thus providing an electrically conductive path for lightning protection.

13. The vent nozzle according to claim 1, wherein at least one section of the vent nozzle is telescopic so that it is configured to increase and decrease in length during use.

14. The vent nozzle according to claim 13, wherein the at least one section of the vent nozzle is the second section.

15. The vent nozzle according to claim 13, wherein the increase and decrease in length of the telescopic section is controlled by a signal from a control unit in dependence on whether the aircraft is on the ground and/or the aircraft is below a threshold ground speed.

16. A fuel system for an aircraft, the fuel system comprising:
at least one fuel storage tank for storage of cryogenic hydrogen,
an overpressure relief valve on the at least one storage tank, and
a vent system for venting gaseous hydrogen from the fuel storage tank via the overpressure relief valve, the vent system terminating in the vent nozzle according to claim 1.

17. An aircraft comprising the fuel system according to claim 16.

18. The aircraft according to claim 17, wherein the aircraft is configurable between a flight configuration and a ground configuration, such that
in the flight configuration, for when the aircraft is in flight, the first outlet either protrudes from the skin of the aircraft by less than 1m or does not protrude at all,
in the ground configuration, for when the aircraft is taxiing or is stationary on the ground, the vertical separation of the first outlet from the highest point of the highest passenger door is at least 3m and
the difference between (a) the vertical separation of the first outlet from a fixed point on the aircraft when in the flight configuration and (b) the vertical separation of the first outlet from the fixed point on the aircraft when in the ground configuration, is more than 5cm.

19. The aircraft according to claim 18, wherein in the flight configuration the majority of the nozzle is contained within the skin of the aircraft, such that it is substantially protected from aerodynamic stresses in flight.

20. A vent nozzle for venting cryogenic gaseous hydrogen from an aircraft, comprising:
a first section connected, via intermediary pipework, to a hydrogen tank,
a second section, the second section projecting upwardly relative to the first section, and being downstream of the first section relative to the hydrogen tank, and
a transitional section between the first section and the second section,
wherein the vent nozzle terminates in a first outlet disposed on the second section,
wherein a second outlet is disposed at least partially on a bottom surface of the transitional section and/or the first section, and
wherein the vent nozzle comprises structure shaped to direct hydrogen towards the first outlet, and away from the second outlet.

21. A method of venting gaseous hydrogen from an aircraft, comprising:
venting hydrogen through a first pipe, the first pipe directing the hydrogen along a first pathway,
directing the hydrogen from the first pipe directly into a second pipe, the second pipe having a larger cross-sectional area than the first pipe at the boundary where the hydrogen passes from the first pipe into the second pipe, the longitudinal axis of the second pipe being angled to the longitudinal axis of the first pipe, the second pipe extending in an upwards direction, and
releasing the hydrogen into the atmosphere via a hydrogen outlet, said outlet being disposed on the second pipe, such that,
water which enters the second pipe through the hydrogen outlet passes out of the second pipe through a second outlet, said second outlet being a gap created between the first pipe and second pipe at the interface.

22. The method according to claim 21, wherein when the venting occurs when the aircraft is on the ground, the second pipe is in an extended configuration, and wherein the method includes telescoping the second pipe into a retracted configuration during take-off, landing, and/or flight of the aircraft.
